(19) United States
(12) Patent Application Publication
(10) Pub. No.: US 2008/0176104 A1
(43) Pub. Date: Jul. 24, 2008

(54) Electroluminescent Device

(75) Inventors: Carl Towns, Essex (GB); Ilaria Grizzi, Cambridge (GB); Stephen O'Connor, Suffolk (GB); Annette Steudel, Cambridge (GB); Jonathan Pillow, Cambridge (GB); Michael Frampton, Oxford (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignees: CDT Oxford Limited, Cambridgeshire (GB); Cambridge Display Technology Limited, Cambridgeshire (GB)

(21) Appl. No.: 10/566,855

(22) PCT Filed: Aug. 2, 2004
(86) PCT No.: PCT/GB04/03332

§ 371 Date: Jan. 16, 2008

(30) Foreign Application Priority Data
Aug. 1, 2003 (GB) 0318018.9
Aug. 11, 2003 (GB) 0318756.4

(51) Int. Cl. B32B 9/04; C08G 73/00

(52) U.S. Cl. 428/704; 528/422; 528/4

(57) ABSTRACT

An electroluminescent device comprising:—a first electrode for injection of positive charge carriers;—a second electrode for injection of negative charge carriers; and—an electroluminescent layer located between the first and second electrodes comprising a host material and a metal complex, wherein the host material comprises a polymer having a first repeat unit of formula (I): wherein each Ar is the same or different and independently represents an optionally substituted aryl or heteroaryl and any two Ar groups may be directly linked by a single bond.

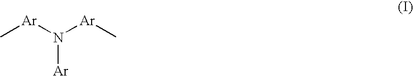

### FIELD OF THE INVENTION

The present invention relates to an electroluminescent device and an electroluminescent polymer therefor.

### BACKGROUND OF THE INVENTION

One class of opto-electrical devices attracting increasing attention is that using a semiconducting organic material for light emission (an electroluminescent device) or as the active component of a photocell or photodetector (a “photovoltaic” device). The basic structure of these devices is a semiconducting organic layer sandwiched between a cathode for injecting or accepting negative charge carriers (electrons) and an anode for injecting or accepting positive charge carriers (holes) into the organic layer.

In an organic light emitting device (OLED), electrons and holes are injected into the semiconducting organic layer where they combine to generate excitons that undergo radiative decay. Various classes of organic light emitting materials are known, in particular: polymers such as poly(p-phenylenevinylene) (as disclosed in WO 90/13148), polyfluorenes and polyphenylenes; the class of materials known as small molecule materials such as tris-(8-hydroxyquinoline)aluminium (“Alq₃”) as disclosed in U.S. Pat. No. 4,539,507; and the class of materials known as dendrimers as disclosed in WO 99/21935. These materials electroluminesce by radiative decay of singlet excitons (i.e. fluorescence) however spin statistics dictate that up to 75% of excitons are triplet excitons which undergo non-radiative decay, i.e. quantum efficiency may be as low as 25% for fluorescent OLEDs—see, for example, Chem. Phys. Lett., 1993, 210, 61, Nature (London), 2001, 409, 494, Synth. Met., 2002, 125, 55 and references therein.

Accordingly, considerable effort has been directed towards producing luminescence from triplet excitons (phosphorescence) by utilising spin-orbit coupling effects in metal complexes that enable triplet excitons to undergo radiative decay. Examples of complexes investigated for this purpose include lanthanide metal chelates [Adv. Mater., 1999, 11, 1349], a platinum (II) porphyrin [Nature (London), 1998, 395, 151] and iridium tris(phenylpyridine) [Appl. Phys. Lett., 1999, 75, 4; Appl. Phys. Left., 2000, 77, 904]. Fuller reviews of such complexes may be found in Pure Appl. Chem., 1999, 71, 2095, Materials Science & Engineering, R: Reports (2002), R39(5-6), 143-222 and Polymeric Materials Science and Engineering (2000), 83, 202-203.

The emissive region of a phosphorescent OLED is made by doping a host material with the phosphorescent metal complex (fluorescent metal complexes may be doped in a host in an analogous manner as described in J. Appl. Phys. 65, 3610, 1989). In operation, singlet and triplet excitons formed by recombination of holes and electrons in the host are transferred to the metal complex and then undergo radiative decay. Efficient devices operating by this mechanism require the triplet energy of the host to be higher than that of the phosphorescent dopant (see Appl. Phys. Lett. 82(7), 1006, 2003). The host may also (or alternatively) transport holes and/or electrons to the metal complex with recombination occuring in the metal complex rather than in the host. In this instance, it is necessary for the host to possess the HOMO level that lies between the workfunction of the anode and the HOMO level of the metal complex (for efficient hole transport) or for the LUMO level of the host to lie between the workfunction of the cathode and the LUMO level of metal complex (for efficient electron injection).

Clearly, choosing an appropriate host material for a given phosphorescent OLED is vital in maximising device performance and will depend on a number of factors including workfunction of the electrodes (in particular the cathode) and the triplet (T1), HOMO and LUMO levels of the metal complex.

Numerous hosts are described in the prior art including “small molecule” hosts such as 4,4′-bis(carbazol-9-yl)biphenyl), known as CBP, and (4,4′,4″-tris(carbazol-9-yl)triphenylamine), known as TCTA, disclosed in Ikai et al. (Appl. Phys. Lett., 79 no. 2, 2001, 156); and triarylamines such as tris-4-(N-3-methylphenyl-N-phenyl)phenylamine, known as MTDATA. Homopolymers are also known as hosts, in particular poly(vinyl carbazole) disclosed in, for example, Appl. Phys. Lett. 2000, 77(15), 2280; polyfluorenes in Synth. Met. 2001, 116, 379, Phys. Rev. B 2001, 63, 235206 and Appl. Phys. Lett. 2003, 82(7), 1006; poly[4-(N-4-vinylbenzyloxyethyl, N-methylamino-N-(2,5-di-tert-butylphenyinapthalimide] in Adv. Mater. 1999, 11(4), 285; and poly(para-phenylenes) in J. Mater. Chem. 2003, 13, 50-55.

In addition to the above homopolymer hosts, a copolymer host is disclosed in J. Chem. Phys. (2003), 118(6), 2853-2864 which discloses poly[9,9′-di-n-hexyl-2,7-fluorene-alt-1,4-(2,5-di-n-hexyloxy)phenylene] as a host for both fac-tris(2-phenylpyridine) iridium(III) and 2,3,7,8,12,13, 17,18-octaethyl-21H,23H-porphydn platinum(II). For both complexes, poor performance was observed. Mat. Res. Symp. Spring Meeting 2003 Book of Abstracts, Heeger, p. 214 discloses red emission from an iridium complex using a random copolymer host of dioctylfluorene and dicyano-benzene. Finally, an AB copolymer of a fluorene repeat unit and phenylene repeat unit is disclosed in Mat. Res. Soc. Symp. Proc. 708, 2002, 131. No significance is attached to the fact that this host is a copolymer; in fact, this disclosure states that this copolymer host produced no singlet- singlet or triplet-triplet energy transfer when used with the iridium and platinum metal complexes.

Polymeric hosts are typically solution processable materials which is a significant advantage because it allows the material to be deposited by inexpensive techniques such as spin-coating or dip-coating. It also allows inkjet printing of the material which is particularly useful in manufacture of full colour displays.

Where the host is a “small molecule”, it is typically deposited by evaporation. Use of small molecules allows a plurality of small molecule layers to be deposited on top of each other. Therefore, phosphorescent OLEDs described in the prior art commonly employ a hole transporting layer and electron transporting layer in addition to the host /phosphorescent metal complex layer (see, for example, J. Appl. Phys. 75(1), 4, 1999).

In contrast, formation of multiple polymeric layers is complicated by the possibility of intermixing between layers when a polymeric material is deposited from solution onto a layer previously deposited from solution.

One solution of providing hole transporting and/or electron transporting functionality in a polymer device over and above that provided by the host material is to blend materials having the necessary functionality with the host. However, it is desirable to minimise the number of components in a blend to avoid potential difficulties with phase separation of the blend.

Another difficulty with using conjugated polymers, such as homopolyfluorene, as hosts is that conjugation between repeat units will reduce the HOMO-LUMO bandgap and reduce the energy level of the triplet excited state (as compared to the unconjugated monomer). The HOMO-LUMO bandgap of the host material must be greater than that of the emissive metal complex. In addition the triplet energy level of the host must be higher than (or at least comparable with) the triplet energy level of the emissive metal complex. Although this might not be problematic for smaller bandgap complexes such as red emitting complexes, it does present difficulties for those metal complexes with wider bandgaps and higher triplet energies such as green and blue emitters.

It is therefore an object of the invention to provide a polymeric host for a phosphorescent OLED that is suitable for a wide range of metal complexes. It is a further object of the invention to provide a polymeric host that possesses good hole and/or electron transporting functionality.

### SUMMARY OF THE INVENTION

The present inventors have surprisingly found that polymers comprising certain triarylamine repeat units are particularly efficacious as hosts for phosphorescent metal complexes and that this efficacity may be optimised by appropriate selection of co-repeat units for the triarylamine repeat units.

Accordingly, in a first aspect the invention provides an electroluminescent device comprising:
a first electrode for injection of positive charge carriers;
a second electrode for injection of negative charge carriers; and
an electroluminescent layer located between the first and second electrodes comprising a host material and a metal complex,
   wherein the host material comprises a polymer having a first repeat unit of formula (I):

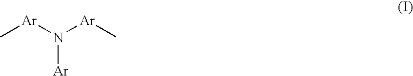

wherein each Ar is the same or different and independently represents an optionally substituted aryl or heteroaryl and any two Ar groups may be directly linked by a single bond.

“Metal complex” as used herein means a metal complex that, when used in an electroluminescent device with a host material, is capable of accepting excitons from the host material and emitting light by radiative decay of the exciton. The metal complex may be capable of fluorescence and/or phosphorescence when used with a host in an electroluminescent device. Preferably, substantially all emission derived from the metal complex is phosphorescence.

The host material may be a homopolymer or a copolymer. Preferably, the polymer is a co-polymer comprising a second repeat unit.

Conjugation of repeat units reduces the triplet energy level of the conjugated units as compared to the triplet energy of non-conjugated units. Therefore, in one embodiment the second repeat unit is at least partially non-conjugated in order to provide a break in conjugation along the polymer backbone and thereby reduce or prevent modulation of the first repeat unit's energy levels by conjugation. This is particularly preferred when the repeat unit of formula (I) possesses the desired energy level for use with a given metal complex, and/or when the metal complex has a high triplet energy level (such as green or blue phosphorescent materials).

Preferred repeat units providing a break in conjugation include repeat units of formulae (II) and (III):

—(CR⁴R⁵)n— (II)

—Ar¹—(CR⁴R⁵)ₙ—Ar²— (III)

wherein R⁴ and R⁵ are independently selected from hydrogen or a substituent; n is from 1-10; and Ar¹ and Ar² are independently selected from optionally substituted aryl or heteroaryl. Preferably, each R⁴ and R⁵ is independently selected from hydrogen or C₁₋₁₀ alkyl; n is 1 or 2; and each Ar¹ and Ar² is phenyl.

In a second embodiment, the second repeat unit is conjugated along its backbone and is conjugated directly to Ar— of the first repeat unit. Appropriate selection of the second repeat unit may therefore be used to modulate the bandgap of the polymer in order to match it to the required triplet, HOMO or LUMO level of the metal complex. The second repeat unit may be planar to allow full conjugation along the polymer backbone or it may incorporate a twist in order to limit conjugation along the polymer backbone without fully breaking conjugation along the backbone as per the first embodiment. Given that the triplet energy of the polymer host must be higher than that of the phosphorescent metal complex, this embodiment is more suited to complexes with lower triplet energy levels, in particular red phosphorescent materials, when repeat units are fully conjugated.

Preferred as fully conjugated repeat units are optionally substituted fluorene, spirofluorene, indenofluorene, phenylene and oligo-phenylene repeat units.

The co-polymer according to the first or second embodiment of the first aspect of the invention is preferably an AB co-polymer.

The first repeat unit may have no bond directly linking two of the Ar groups. In this case, the repeat unit of formula (I) is preferably selected from repeat units of formulae 1-6:

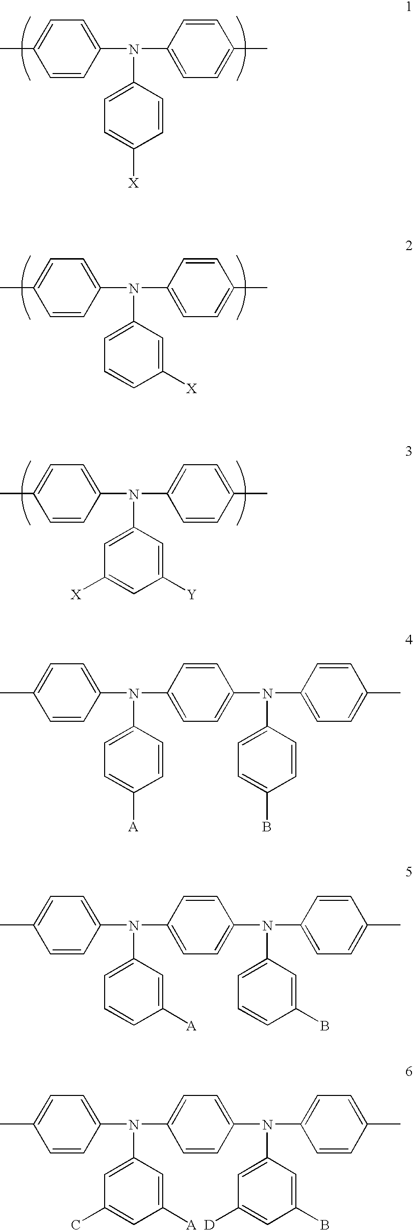

wherein X, Y, A, B, C and D are independently selected from H or a substituent group. More preferably, one or more of X, Y, A, B, C and D is independently selected from the group consisting of optionally substituted, branched or linear alkyl, aryl, perfluoroalkyl, thioalkyl, cyano, alkoxy, heteroaryl, alkylaryl and arylalkyl groups. Most preferably, X, Y, A and B are C₁₋₁₀ alkyl. The repeat unit of formula 1 is most preferred.

Alternatively, the repeat unit of formula (I) may have a single bond between two Ar groups. In this case, repeat units of formula (IV) are preferred:

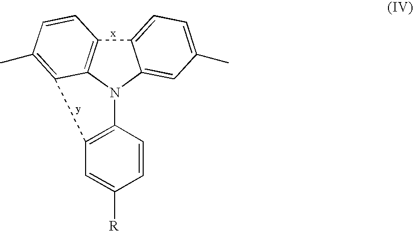

wherein R is hydrogen or a substituent and one of x and y is present as a single bond.

Where bond x is present, a particularly preferred unit is an optionally substituted repeat unit of formula (IVa):

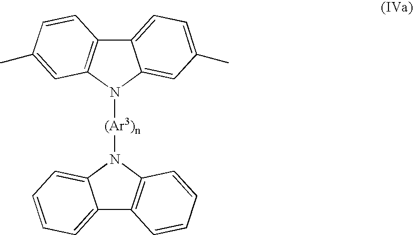

Where bond y is present, a particularly preferred repeat unit is an optionally substituted repeat unit of formula (IVb):

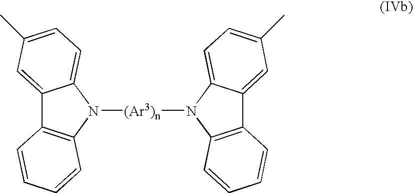

wherein n is 1 or 2 and each Ar³ independently represents an optionally substituted aryl or heteroaryl group and wherein the two Ar³ groups may be fused together. In one preferred embodiment (for both n=1 and n=2), Ar³ in units IVa and IVb is phenyl, in which case each phenyl is a 1,4-linked phenylene. In another preferred embodiment, n =2 and the two Ar³ groups are fused together to form a 2,7-linked fluorene unit.

In one preferred embodiment, the polymer and metal complex may be combined in the form of a physical blend. In another preferred embodiment, the metal complex is chemically bound to the polymer as a substituent attached to the polymer main chain (i.e. polymer backbone) or incorporated into the polymer main chain.

Preferably, the metal complex is provided as a repeat unit within the polymer or as an end-group of the polymer.

In a second aspect, the invention provides a composition comprising a metal complex and a polymer as described in the first aspect of the invention.

In a third aspect, the invention provides an electroluminescent polymer comprising a repeat unit of formula (I) and a metal complex bound to the polymer as a substituent attached to the polymer main chain or incorporated into the polymer main chain:

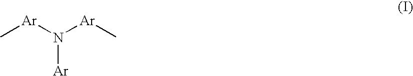

wherein each Ar is the same or different and independently represents an optionally substituted aryl or heteroaryl and any two Ar groups may be directly linked by a single bond.

The electroluminescent polymer may be a homopolymer with a metal complex bound directly to at least one of the repeat units of formula (I). Alternatively, the electroluminescent polymer may be a copolymer in which case the metal complex may (a) form a co-repeat unit within the polymer backbone or (b) be directly bound to the repeat unit of formula (I).

In view of the aforementioned advantages of combining the repeat unit of formula (I) and a metal complex, it is preferred that the metal complex is bound to the repeat unit of formula (I). More preferably, the metal complex is present as part of a repeat unit of formula (XII):

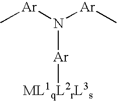

wherein M is a metal; each of L¹, L² and L³ is a coordinating group; q is an integer; r and s are each independently 0 or an integer; and the sum of (a. q)+(b. r)+(c.s) is equal to the number of coordination sites available on M, wherein a is the number of coordination sites on L¹, b is the number of coordination sites on L² and c is the number of coordination sites on L³.

Ar and L¹ may be linked to form a bidentate ligand bound to metal M.

L¹, L² and L³ may each independently be a mono- or polydentate ligand. Two or all of L¹, L² and L³ may be linked to form a polydentate ligand.

Preferably, the metal complex is phosphorescent.

In a fifth aspect, the invention provides monomer of formula (XIII):

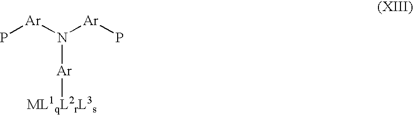

wherein each Ar is the same or different and independently represents an optionally substituted aryl or heteroaryl; any two Ar groups may be directly linked by a single bond; M is a metal; each of L¹, L² and L³ is a coordinating group; q is an integer; r and s are each independently 0 or an integer; the sum of (a. q)+(b. r)+(c.s) is equal to the number of coordination sites available on M, wherein a is the number of coordination sites on L¹, b is the number of coordination sites on L² and c is the number of coordination sites on L³; and each P is the same or different and is a polymerisable group.

In one preferred embodiment, the metal complex ML¹_{q}L²ᵣL³ₛ s is bound to the pendant aryl of the triarylamine through a bond with one or more of L¹, L² and L³. In another preferred embodiment, the Ar and L¹ are linked to form a bidentate ligand bound to metal M.

L¹, L² and L³ may each independently be a mono- or polydentate ligand. Two or all of L¹, L² and L³ may be linked to form a polydentate ligand.

Preferably, each P is independently selected from boronic acid, boronic ester, borane or halogen.

### BRIEF DESCRIPTION OF THE DRAWINGS

The present invention will now be described in further detail, by way of example only, with reference to the accompanying drawing in which:

FIG. 1 shows an organic electroluminescent device according to the invention

### DETAILED DESCRIPTION OF THE INVENTION

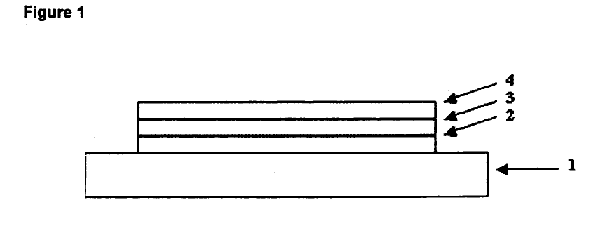

With reference to FIG. 1, the standard architecture of an electroluminescent device according to the invention comprises a transparent glass or plastic substrate 1, an anode of indium tin oxide 2 and a cathode 4. The electroluminescent layer according to the invention is layer 3 between anode 2 and cathode 4.

In addition to layer 3, a separate hole transporting layer and/or an electron transporting layer may be provided.

Although not essential, a layer of organic hole injection material (not shown) between the anode 2 and the polymer layer 3 is desirable because it assists hole injection from the anode into the layer or layers of semiconducting polymer. Examples of organic hole injection materials include poly(ethylene dioxythiophene) (PEDT/PSS) as disclosed in EP 0901176 and EP 0947123, or polyaniline as disclosed in U.S. Pat. No. 5,723,873 and U.S. Pat. No. 5,798,170.

Cathode 4 is selected from materials that have a workfunction allowing injection of electrons into the electroluminescent layer. Other factors influence the selection of the cathode such as the possibility of adverse interactions between the cathode and the electroluminescent material. The cathode may consist of a single material such as a layer of aluminium. Alternatively, it may comprise a plurality of metals, for example a bilayer of calcium and aluminium as disclosed in WO 98/10621, elemental barium disclosed in WO 98/57381, Appl. Phys. Lett. 2002, 81(4), 634 and WO 02/84759 or a thin layer of dielectric material to assist electron Injection, for example lithium fluoride disclosed in WO 00/48258 or barium fluoride, disclosed in Appl. Phys. Lett. 2001, 79(5), 2001.

A typical electroluminescent device comprises an anode having a workfunction of 4.8 eV. Accordingly, the HOMO level of the hole transporting region is preferably around 4.8-5.5 eV. Similarly, the cathode of a typical device will have a workfunction of around 3 eV. Accordingly, the LUMO level of the electron transporting region is preferably around 3-3.5 eV.

Electroluminescent devices may be monochrome devices or full colour devices (i.e. formed from red, green and blue electroluminescent materials).

1) Electroluminescent Layer 3

Electroluminescent layer 3 may comprise the host polymer and metal complex according to the invention alone or one or more additional materials. In particular, layer 3 may comprise the host polymer and metal complex according to the invention blended with one ore more of a hole transporting polymer and an electron transporting polymer as disclosed in WO 99/48160.

2) Host Polymer

The host polymer may be a homopolymer or a copolymer. Where it is a copolymer, the first and second repeat units of the copolymer may be arranged to give any form of co-polymer such as an AB, random or block co-polymer. The co-polymer may comprise further repeat units in addition to the first and second repeat units. For example, a third repeat unit may be provided with the first and second repeat units to form a block or random co-polymer.

The co-polymer may comprise hole transporting regions and electron transporting regions as disclosed in, for example, WO 00/55927 and U.S. Pat. No. 6,353,083. For example, a region comprising units of formula (I) will typically provide hole transporting functionality. Similarly, an electron transporting region may comprise a chain of polyfluorene units, or repeat units of electron deficient heterocycles as disclosed in, for example, Polym. Adv. Technol. 1998, 9, 429-42 and J. Mater. Chem. 200, 10, 1-25. The different regions within such a polymer may be provided along the polymer backbone, as per U.S. Pat. No. 6,353,083, or as groups pendant from the polymer backbone as per WO 01/62869.

The metal complex may be incorporated into the host polymer, either as a substituent on the main chain of the homopolymer or incorporated into the main chain of the copolymer, as disclosed in, for example, EP 1245659, WO 02/31896, WO 03/18653 and WO 03/22908. In this case, the copolymer may provide the functions of emission and at least one of hole transport and electron transport.

Preferred methods for preparation of these polymers are Suzuki polymerisation as described in, for example, WO 00/53656 and Yamamoto polymerisation as described in, for example, T. Yamamoto, “Electrically Conducting And Thermally Stable π—Conjugated Poly(arylene)s Prepared by Organometallic Processes”, Progress in Polymer Science 1993, 17, 1153-1205. These polymerisation techniques both operate via a “metal insertion” wherein the metal atom of a metal complex catalyst is inserted between an aryl group and a leaving group of a monomer. In the case of Yamamoto polymerisation, a nickel complex catalyst is used; in the case of Suzuki polymerisation, a palladium complex catalyst is used.

For example, in the synthesis of a linear polymer by Yamamoto polymerisation, a monomer having two reactive halogen groups is used. Similarly, according to the method of Suzuki polymerisation, at least one reactive group is a boron derivative group such as a boronic acid or boronic ester and the other reactive group is a halogen. Preferred halogens are chlorine, bromine and iodine, most preferably bromine.

It will therefore be appreciated that repeat units and end groups comprising aryl groups as illustrated throughout this application may be derived from a monomer carrying a suitable leaving group.

Suzuki polymerisation may be used to prepare regioregular, block and random copolymers. In particular, homopolymers or random copolymers may be prepared when one reactive group is a halogen and the other reactive group is a boron derivative group. Alternatively, block or regioregular, in particular AB, copolymers may be prepared when both reactive groups of a first monomer are boron and both reactive groups of a second monomer are halogen.

Other leaving groups capable of participating in metal insertion include groups such as tosylate, mesylate and triflate.

3) Metal Complex

Preferred metal complexes comprise optionally substituted complexes of formula (V):

ML¹_{q}L²ᵣL³ₛ (V)

wherein M is a metal; each of L¹, L² and L³ is a coordinating group; q is an integer; r and s are each independently 0 or an integer; and the sum of (a. q)+(b. r)+(c.s) is equal to the number of coordination sites available on M, wherein a is the number of coordination sites on L¹, b is the number of coordination sites on L² and c is the number of coordination sites on L³.

Heavy elements M induce strong spin-orbit coupling to allow rapid intersystem crossing and emission from triplet states (phosphorescence). Suitable heavy metals M include:
lanthanide metals such as cerium, samarium, europium, terbium, dysprosium, thulium, erbium and neodymium; and
d-block metals, in particular those in rows 2 and 3 i.e. elements 39 to 48 and 72 to 80, in particular ruthenium, rhodium, pallaidum, rhenium, osmium, iridium, platinum and gold.

Suitable coordinating groups for the f-block metals include oxygen or nitrogen donor systems such as carboxylic acids, 1,3-diketonates, hydroxy carboxylic acids, Schiff bases including acyl phenols and iminoacyl groups. As is known, luminescent lanthanide metal complexes require sensitizing group(s) which have the triplet excited energy level higher than the first excited state of the metal ion. Emission is from an f-f transition of the metal and so the emission colour is determined by the choice of the metal. The sharp emission is generally narrow, resulting in a pure colour emission useful for display applications.

The d-block metals form organometallic complexes with carbon or nitrogen donors such as porphyrin or bidentate ligands of formula (VI):

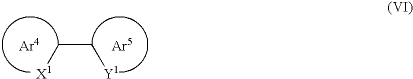

wherein Ar⁴ and Ar⁵ may be the same or different and are independently selected from optionally substituted aryl or heteroaryl; X¹ and Y² may be the same or different and are independently selected from carbon or nitrogen; and Ar⁴ and Ar⁵ may be fused together. Ligands wherein X¹ is carbon and Y¹ is nitrogen are particularly preferred.

Examples of bidentate ligands are illustrated below:

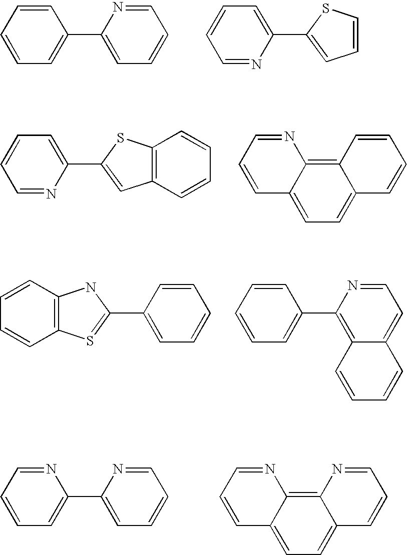

Each of Ar⁴ and Ar⁵ may carry one or more substituents. Particularly preferred substituents include fluorine or trifluoromethyl which may be used to blue-shift the emission of the complex as disclosed in WO 02/45466, WO 02/44189, US 2002-117662 and US 2002-182441; alkyl or alkoxy groups as disclosed in JP 2002-324679; carbazole which may be used to assist hole transport to the complex when used as an emissive material as disclosed in WO 02/81448; bromine, chlorine or iodine which can serve to functionalise the ligand for attachment of further groups as disclosed in WO 02/68435 and EP 1245659; and dendrons which may be used to obtain or enhance solution processability of the metal complex as disclosed in WO 02/66552.

Other ligands suitable for use with d-block elements include diketonates, in particular acetylacetonate (acac); triarylphosphines and pyridine, each of which may be substituted.

Main group metal complexes show ligand based, or charge transfer emission. For these complexes, the emission colour is determined by the choice of ligand as well as the metal. A wide range of fluorescent low molecular weight metal complexes are known and have been demonstrated in organic light emitting devices [see, e. g., Macromol. Sym. 125 (1997) 1-48, U.S. Pat. No. 5,150,006, U.S. Pat. No. 6,083,634 and U.S. Pat. No. 5,432,014], in particular tris-(8-hydroxyquinoline)aluminium. Suitable ligands for di or trivalent metals include: oxinoids, e. g. with oxygen-nitrogen or oxygen-oxygen donating atoms, generally a ring nitrogen atom with a substituent oxygen atom, or a substituent nitrogen atom or oxygen atom with a substituent oxygen atom such as 8-hydroxyquinolate and hydroxyquinoxalinol-10-hydroxybenzo (h) quinolinato (II), benzazoles (III), schiff bases, azoindoles, chromone derivatives, 3-hydroxyflavone, and carboxylic acids such as salicylato amino carboxylates and ester carboxylates. Optional substituents include halogen, alkyl, alkoxy, haloalkyl, cyano, amino, amido, sulfonyl, carbonyl, aryl or heteroaryl on the (hetero) aromatic rings which may modify the emission colour.

As outlined above, the metal complex may be blended with the host polymer or it may be chemically bound to the polymer as a sidechain or as a repeat unit within the polymer. An example of a metal complex bound to the repeat unit of formula (I) is as follows:

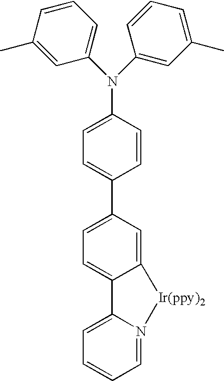

This arrangement is particularly advantageous because the pendant aryl group of the triarylamine unit (phenyl in the above illustration) and the ligand of the metal complex that the pendant aryl is bound to (phenylpyridine in the above illustration) are co-planar, thus maximising conjugation between the metal complex and the repeat unit. In contrast, metal complexes bound to an arylene repeat unit of the polymer backbone (for example, as disclosed in WO 03/22908) are not co-planar with the arylene repeat unit.

A monomer with a pendant metal complex, which may be polymerised to form a corresponding repeat unit, may be formed as follows:

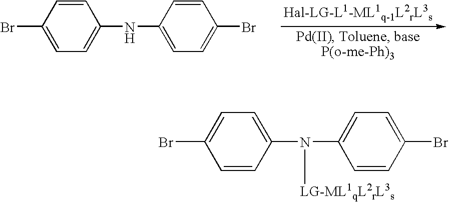

wherein Hal represents a halogen and LG represents an aryl or heteroaryl linking group, in particular 1,4-phenylene.

The metal complex may alternatively form a repeat unit within the polymer backbone. In this case, one suitable class of monomers for producing such repeat units are those having formula (VII):

P-L¹-M(L¹_{q-2}L²ᵣL³ₛ)-L¹-P (VII)

Repeat units derived from monomers of formula (VII) contain two ligands L¹ and metal M in the polymer backbone. An example of such a monomer is as follows, as disclosed in WO 02/068435:

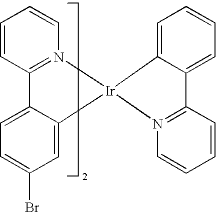

It will be appreciated that, for monomers of formula (VIII), q is at least 2.

4) Copolymer Second Repeat Unit

The second repeat unit of the co-polymer comprising the repeat unit of formula (I) may be selected from a wide range of repeat units according to the required properties of the end polymer, in particular as follows:

a) Conjugated, Substantially Planar Second Repeat Units

One class of second repeat units are arylene repeat units, in particular: 1,4-phenylene repeat units as disclosed in J. Appl. Phys. 1996, 79, 934; fluorene repeat units as disclosed in EP 0842208, indenofluorene repeat units as disclosed in, for example, Macromolecules 2000, 33(6), 2016-2020 and spirofluorene repeat units as disclosed in, for example EP 0707020. Each of these repeat units is optionally substituted. Examples of substituents include solubilising groups such as C₁₋₂₀ alkyl or alkoxy; electron withdrawing groups such as fluorine, nitro or cyano; and substituents for increasing glass transition temperature (Tg) of the polymer.

Fluorene repeat units are planar and so are particularly useful where conjugation along the polymer backbone is desirable. Particularly preferred are optionally substituted, 2,7-linked fluorenes, most preferably repeat units of formula VIII:

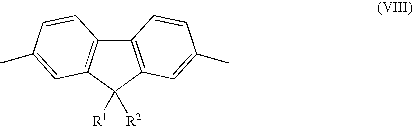

wherein R¹ and R² are independently selected from hydrogen or optionally substituted alkyl, alkoxy, aryl, arylalkyl, heteroaryl and heteroarylalkyl, and at least one of R¹ and R² is not hydrogen. More preferably, at least one of R¹ and R² comprises an optionally substituted C₄-C₂₀ alkyl or aryl group.

Polymers of the invention containing repeat units of this type are advantageous as hosts for relatively small bandgap emitters, such as red emitters.

b) Conjugated, Non-Planar Second Repeat Units

Non-planar repeat units include units containing a twist caused by steric interaction between a substituent of the non-planar repeat unit and ring bearing substituents capable of inducing a twist between adjacent ring systems by steric interaction.

One class of repeat unit capable of producing a twist in the polymer backbone is that comprising an optionally substituted repeat unit of formula (IX):

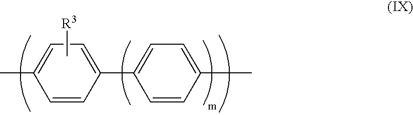

wherein m is 1 or 2 and R³ is a substituent, preferably an optionally substitued alkyl, alkoxy, aryl, aryloxy, heteroaryl or heteroaryloxy group, more preferably a C₁₋₁₀ alkyl group.

The group R³ induces a twist by steric interaction with the phenyl group of the repeat unit of formula (IX) adjacent to the phenyl group that R³ is attached to. In this case, preferred repeat units include repeat units of formulae (X) or (XI):

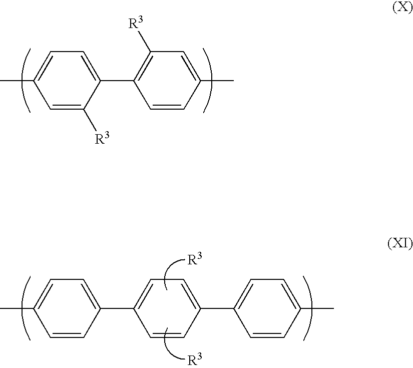

Alternatively, the group R³ may induce a twist by steric interaction with a repeat unit adjacent to the repeat unit of formula (IX). In this case, R³ is attached to the carbon atom adjacent to the carbon atom of the repeat unit that is linked to said adjacent repeat unit.

Polymers of the invention containing non-planar, conjugating repeat units of this type are suitable for use as hosts with wider bandgap emitters than corresponding polymers with planar, conjugated repeat units.

c) Partially or Fully Non-Conjugated Repeat Units

Particular examples of partially or fully non-conjugated repeat units have formulae 7-10 (dotted lines show bonds for linkage to further repeat units). Repeat units having an aryl group at either end are particularly advantageous because they are readily formed from the appropriate monomers by Suzuki or Yamamoto polymerisation.

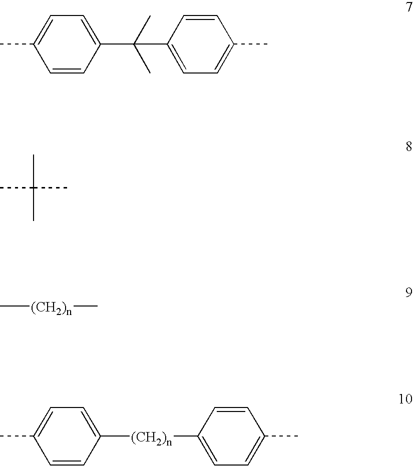

These second repeat units are particularly suitable for use with first repeat units (IVa) and (IVb) because of the high triplet energies of those units. Furthermore, units (IVa) and (IVb) are capable of providing both hole and electron transporting functionality.

Break in conjugation may also be provided by a silicon atom located in the polymer backbone, for example —Si(Ak)₂— where Ak is an alkyl group; group 5 elements, for example —P(Ak)—; and group 6 elements, e.g. oxygen and sulfur atoms.

Polymers of the invention containing repeat units of this type are suitable for relatively wide bandgap materials.

### EXAMPLES

General Procedure

A green emitting complex 11 or red-emitting complex 12 (as disclosed in WO 02/66552) and a host polymer were deposited by spin coating from xylene solution onto a glass substrate comprising a layer of indium tin oxide, which may optionally be provided with a layer of hole injection material such as PEDT/PSS, or a hole transporting material. An electron transporting/hole blocking layer may optionally also be provided between the electroluminescent layer and the cathode. A bilayer cathode of calcium/aluminium was deposited over the electroluminescent layer and the device was encapsulated using an airtight metal enclosure available from Saes Getters SpA.

2,3,7,8,12,13,17,18-octaethyl-21H,23H-porphyrin platinum(II) may be used as an alternative to red emitting complex 12.

A bilayer cathod of lithium fluoride/aluminium may be used as an alternative to calcium/aluminium.

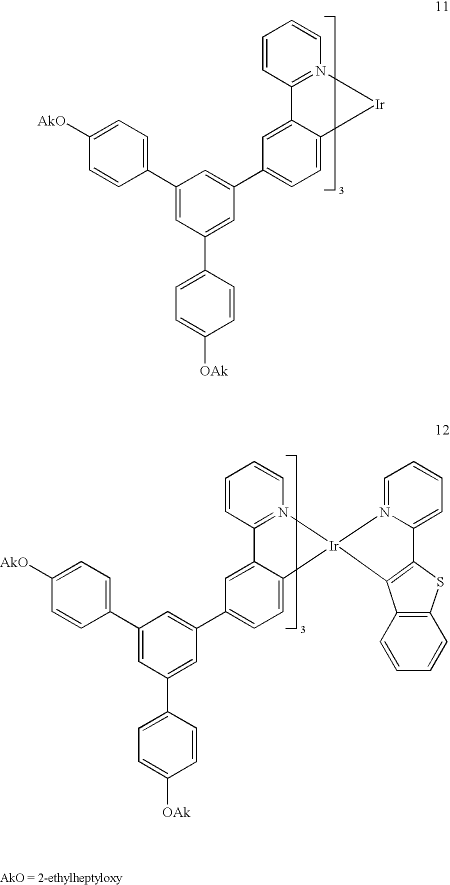

Devices were prepared using the following hosts:

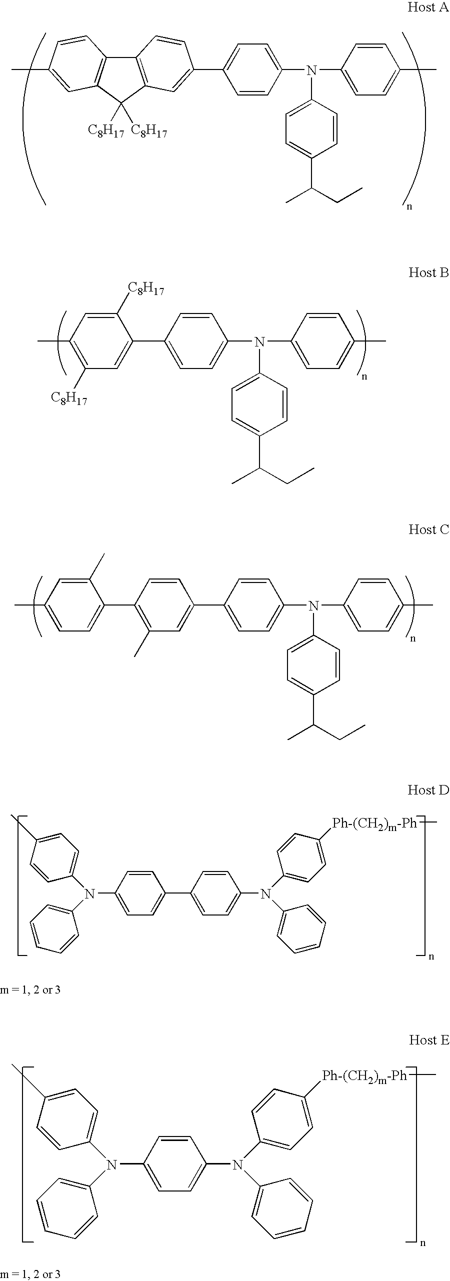

Hosts A-E were used as hosts for red emitting complex 12, however only the hosts C-E, which have second repeat units giving reduced conjugation or breaks in conjugation, were used as the host for green-emitting complex 11.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. An electroluminescent device comprising:
a first electrode for injection of positive charge carriers;
a second electrode for injection of negative charge carriers; and
an electroluminescent layer located between the. first and second electrodes comprising a host material and a metal complex,
wherein the host material comprises a polymer having a first repeat unit of formula (I): 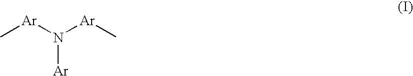
wherein each Ar is the same or different and independently represents an optionally substituted aryl or heteroaryl and any two Ar groups may be directly linked by a single bond.

2. An electroluminescent device according to claim 1 wherein the polymer is a co-polymer comprising a second repeat unit.

3. An electroluminescent device according to claim 2 wherein the second repeat unit is at least partially non-conjugated.

4. An electroluminescent device according to claim 3 wherein the second repeat unit is selected from repeat units of formulae (II) and (III):
—(CR⁴R⁵)ₙ— (II)
—Ar¹—(CR⁴R⁵)ₙ—Ar²— (III)
wherein R⁴ and R⁵ are independently selected from hydrogen or a substituent; n is from 1-10; and Ar¹ and Ar² are independently selected from optionally substituted aryl or heteroaryl.

5. An electroluminescent device according to claim 4 wherein each R⁴ and R⁵ is independently selected from hydrogen or C₁₋₁₀ alkyl; n is 1 or 2; and each Ar¹ and Ar² is phenyl.

6. An electroluminescent device according to claim 2 wherein the second repeat unit is fully conjugated along its backbone and is conjugated directly to Ar— of the first repeat unit.

7. An electroluminescent device according to claim 6 wherein the second repeat unit is selected from the group consisting of optionally substituted fluorene, spirofluorene, indenofluorene, phenylene and oligo-phenylene.

8. An electroluminescent device according to claim 2 wherein the co-polymer is an AB co-polymer.

9. An electroluminescent device according to claim 1 wherein none of the Ar groups of the first repeat unit are directly linked by a single bond.

10. An electroluminescent device according to claim 1 wherein the first repeat unit comprises an optionally substituted repeat unit of formula (IV): 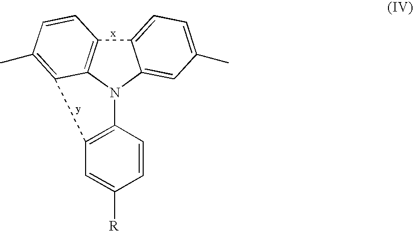
wherein R is hydrogen or a substituent and one of x and y is present as a single bond.

11. An electroluminescent device according to claim 1 wherein the metal complex is chemically bound to the polymer as a substituent attached to the polymer main chain or incorporated into the polymer main chain.

12. An electroluminescent device according to claim 11 wherein the metal complex is provided as a repeat unit within the polymer.

13. An electroluminescent device according to claim 12 wherein the metal complex is provided as an end-group of the polymer.

14. An electroluminescent device according to claim 1 wherein the metal complex is electrophosphorescent.

15. A composition comprising a metal complex and a polymer as defined in claim 1.

16. An electroluminescent polymer comprising a repeat unit of formula (I) and a metal complex bound to the polymer as a substituent attached to the polymer main chain or incorporated into the polymer main chain: 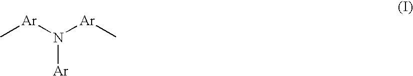
wherein each Ar is the same or different and independently represents an optionally substituted aryl or heteroaryl and any two Ar groups may be directly linked by a single bond.

17. An electroluminescent polymer according to claim 16 wherein the metal complex is bound directly to the repeat unit of formula (I).

18. An electroluminescent polymer according to claim 17 comprising a repeat unit of formula (XII): 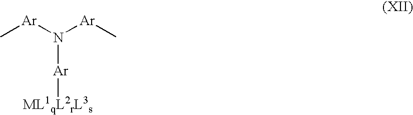
wherein M is a metal; each of L¹, L² and L³ is a coordinating group; q is an integer; r and s are each independently 0 or an integer; and the sum of (a. q)+(b. r)+(c.s) is equal to the number of coordination sites available on M, wherein a is the number of coordination sites on L¹, b is the number of coordination sites on L² and c is the number of coordination sites on L³.

19. An electroluminescent polymer according to claim 16 wherein the metal complex is phosphorescent.

20. A monomer of formula (XIII): 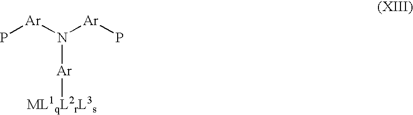
wherein each Ar is the same or different and independently represents an optionally substituted aryl or heteroaryl; any two Ar groups may be directly linked by a single bond; M is a metal; each of L¹, L² and L³ is a coordinating group; q is an integer; r and s are each independently 0 or an integer; the sum of (a. q)+(b. r)+(c.s) is equal to the number of coordination sites available on M, wherein a is the number of coordination sites on L¹, b is the number of coordination sites on L² and c is the number of coordination sites on L³; and each P is the same or different and is a polymerisable group.

21. A monomer according to claim 20 wherein each P is independently selected from the group consisting of boronic acid, boronic ester, borane and halogen.
